(19) United States
(12) Patent Application Publication
(10) Pub. No.: US 2005/0014394 A1
(43) Pub. Date: Jan. 20, 2005

(54) Contact-connection device for electronic circuit units and production method

(75) Inventors: Harry Hedler, Germering (DE); Roland Irsigler, Munchen (DE); Thorsten Meyer, Erlangen (DE); Peter Weitz, Sauerlach (DE)

Correspondence Address: MORRISON & FOERSTER LLP, 1650 TYSONS BOULEVARD, SUITE 300, MCLEAN, VA, 22102, US

(73) Assignee: INFINEON TECHNOLOGIES, Munich (DE)

(21) Appl. No.: 10/855,891

(22) Filed: May 28, 2004

(30) Foreign Application Priority Data
May 28, 2003 (DE) 103 24 450.6

(51) Int. Cl. H01R 29/00

(52) U.S. Cl. 439/55

(57) ABSTRACT

A contact-connection device for electronic circuit units includes an adapter board, at least one elastic element arranged on the adapter board, conductor tracks arranged on the at least one elastic element and the adapter board, conductor track connecting elements deposited on the adapter board and electrically connected to the conductor tracks, and contact-connection elements deposited on the at least one elastic element and electrically connected to the conductor tracks, the contact-connection elements contact-connecting circuit unit connecting elements of the circuit units in an elastically pressing-on fashion.

### CLAIM FOR PRIORITY

This application claims priority to German Application No. 10324450.6 filed May 28, 2003, which is incorporated herein, in its entirety, by reference.

### TECHNICAL FIELD OF THE INVENTION

The present invention relates to a contact-connection system for use when testing electronic circuit units or chips to be tested, and in particular to a contact-connection device for electronic circuit units and a method for producing the same.

### BACKGROUND OF THE INVENTION

The increasing fabrication density of present-day electronic circuits or electronic circuit units, also referred to as chips, leads to increased requirements during testing. Prior to delivery, the electronic circuit units have to be subjected to various tests. In this case, the electronic circuit units accommodated in housings (packages) are conventionally contact-connected to the housing contacts by means of a so-called needle card, the needle card usually having resilient contact pins.

During contact-connection, the circuit units to be tested are subjected to various test conditions. By way of example, test series are carried out at an elevated temperature over a relatively long period of time, e.g. 120° C. for a time duration of 24 hours. These test series are also referred to as “burn-in”. In this case, long test times can rapidly lead to high test costs and economic disadvantages; by way of example, up to 5000 wafers each having 1000 chips are tested in a “burn in” series.

For the purpose of efficient contact-connection of the circuit units to be tested, it has been proposed to provide receptacles into which the circuit units to be tested are introduced.

One essential disadvantage of known methods for the contact-connection of electronic circuit units is that said circuit units have to be provided with a housing and corresponding connecting contacts outside the housing.

Conventional contact-connection devices cannot be used for circuit units to be tested without a housing, i.e. so-called “bare chips”. There is an increasing need to provide so-called multi-chip modules, i.e. different chips or circuit units are accommodated in a single module.

In this case, the individual circuit units may perfectly well be supplied by different manufacturers. An important aspect in the supply of circuit units without a housing is that said circuit units have to be checked for defects just as carefully as housed circuit units.

It is disadvantageous that it is not possible to use conventional contact-connection devices and methods for testing electronic circuit units without a housing either in the state still joined in the wafer or after the chips have been singulated. In this case, a pitch distance or a contact-connection distance of the connecting elements of a circuit unit is in the region of down to 50 μm. With present-day contact-connection systems, it is possible to achieve an alignment accuracy of 5 μm to 10 μm by means of corresponding positioning devices.

### SUMMARY OF THE INVENTION

It is an object of the present invention to provide a contact-connection device for non-housed electronic circuit units and also a method for producing the contact-connection device.

An essential concept of the invention consists in depositing conductor tracks with the pitch distance of connecting elements of the electronic circuit unit to be tested on an adapter board on an elastic element fitted on the adapter board, in such a way that contact-connection elements are provided on the elastic element in a manner projecting from the adapter board, which contact-connection elements contact-connect the connecting elements of the electronic circuit unit to be tested in elastically pressing-on fashion.

The advantage of the device according to the invention is that electronic circuit units without a housing can now be contact-connected and thus tested, for example.

A further advantage of the contact-connection device according to the invention is that different electronic circuit units to be tested can be reliably tested prior to an arrangement in a multi-chip module. Consequently, in the multi-chip module, only reliably tested electronic circuit units are used and subsequently provided with a housing.

According to an aspect of the invention, the contact-connection device includes an adapter board, on which the entire contact-connection system is advantageously arranged; at least one elastic element arranged on the adapter board; conductor tracks deposited on the at least one elastic element and the adapter board, the conductor tracks on the adapter board and the at least one elastic element being electrically connected to one another; conductor track connecting elements deposited on the adapter board and electrically connected to the conductor tracks, which conductor track connecting elements advantageously provide a contact-connection to external circuit devices, it expediently being possible for the conductor track connecting elements to be contact-connected through the adapter board; and contact-connection elements deposited on the at least one elastic element and electrically connected to the conductor tracks, which contact-connection elements are advantageously provided for the contact-connection of connecting elements of the circuit unit, in such a way that the contact-connection elements contact-connect the circuit unit connecting elements of the circuit unit in elastically pressing-on fashion.

Furthermore, the method according to the invention for producing a contact-connection device for electronic circuit units having circuit unit connecting elements includes providing an adapter board as carrier plate; depositing at least one elastic element on the adapter board; depositing conductor tracks on the adapter board and on the at least one elastic element; depositing conductor track connecting elements electrically connected to the conductor tracks on the adapter board; and depositing contact-connection elements electrically connected to the conductor tracks on the at least one elastic element, the contact-connection elements contact-connecting the circuit unit connecting elements of the circuit unit in elastically pressing-on fashion.

In accordance with one aspect of the present invention, external circuit devices can be connected to the conductor track connecting elements, in such a way that it is possible to supply test signals for testing the electronic circuit unit to be tested.

In accordance with a further aspect of the present invention, the elastic element is formed as a semi-cylinder.

In accordance with yet another aspect of the present invention, the elastic element is embodied from a thermo-stable elastic material, thus affording the advantage that, during a contact-connection of the electronic circuit unit to be tested, it is possible to employ high temperatures, typically 120° C., for a relatively long time duration, typically 24 hours.

In accordance with yet another aspect of the present invention, the elastic element comprises a silicone material. Furthermore, it is advantageous for the elastic element to comprise a dielectric material which provides an electrical insulation with respect to the adapter board with respect to the conductor tracks to be applied on the elastic element.

In accordance with yet another aspect of the present invention, the elastic element has a cross-sectional form which issues symmetrically with respect to a thickening region in shallow fashion toward the edges of the thickening region. In order to insulate the conductor tracks from one another and the adapter board from the conductor tracks, the elastic element advantageously comprises an electrically nonconductive material.

In accordance with yet another aspect of the present invention, the contact-connection elements deposited on the elastic element and electrically connected to the conductor tracks have a pitch distance of 50 μm to 100 μm.

In accordance with yet another aspect of the present invention, the elastic element has a cross-sectional form which provides volume-specific elasticity properties.

In accordance with yet another aspect of the present invention, the conductor tracks deposited on the elastic element project from the surface of the elastic element, so that circuit unit connecting elements which are lowered with regard to a circuit unit board side can also advantageously be contact-connected.

In accordance with yet another aspect of the present invention, the conductor tracks deposited on the elastic element and the adapter board are embodied in one row or in two lines.

In accordance with yet another aspect of the present invention, cutouts are provided between the contact-connection elements by dry etching of the at least one elastic element.

In accordance with yet another aspect of the present invention, cutouts are provided between the contact-connection elements by a relief printing on the elastic element.

In accordance with yet another aspect of the present invention, the conductor tracks, the contact-connection elements and the conductor track connecting elements are applied by a sputtering technique and a subsequent electrochemical reinforcement on the adapter board and the at least one elastic element.

### BRIEF DESCRIPTION OF THE DRAWINGS

FIG. 1 shows a contact-connection device for electronic circuit units in accordance with a preferred exemplary embodiment of the present invention, an elastic element being deposited on an adapter board and deposited conductor tracks being embodied in two lines on the elastic element;

FIG. 2 shows a modification of the exemplary embodiment in accordance with FIG. 1, two elastic elements each occupied by one row of deposited conductor tracks being provided;

FIG. 3 shows an arrangement in accordance with the exemplary embodiments of FIG. 1, the conductor tracks deposited on the elastic element projecting on the surface of the elastic element;

FIG. 4 shows a cross-sectional view along the line A-A of FIG. 3, a relief structure being provided by dry etching;

FIG. 5 shows a cross-sectional view along the line A-A of FIG. 3, a relief structure being provided by means of a relief printing on the elastic element; and

FIG. 6 shows a lateral cross-sectional view along the line A-A of FIG. 3, illustrating a circuit unit with circuit unit connecting elements in a state prior to contact-connection.

### DETAILED DESCRIPTION OF THE INVENTION

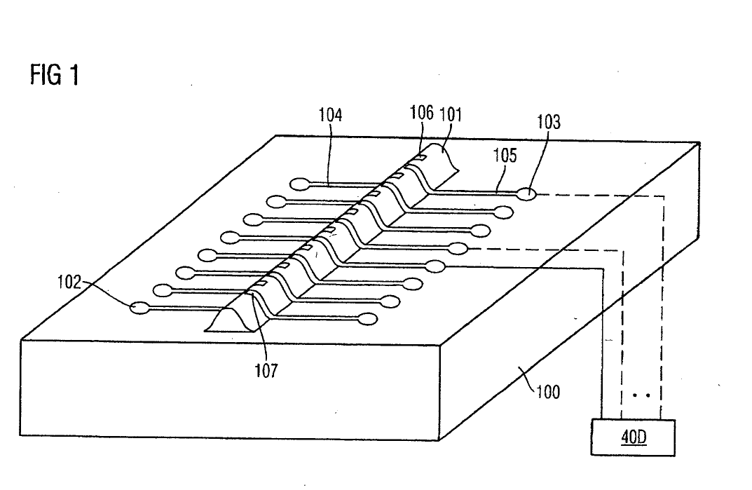

In the arrangement shown in FIG. 1, an elastic element 101 is fitted on an adapter board 100. Electrically conductive conductor tracks 104 and 105 run on both sides of the elastic element between the elastic element and respective conductor track connecting elements 102 and 103.

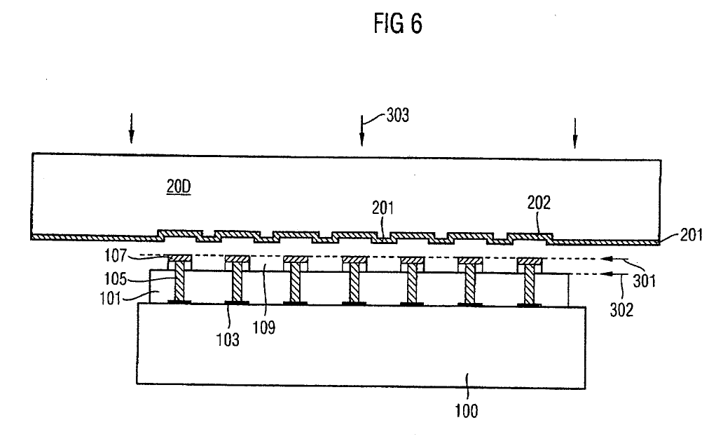

The conductor track connecting elements can be contact-connected through the adapter board 100 and provide a connecting possibility for an external circuit device 400. The external circuit device 400 may be formed for example as a test device which supplies test signals to a circuit unit 200 to be tested (see FIG. 6) and carries response signals away from said circuit unit 200 to be tested.

It should be pointed out that the electronic circuit unit 200 to be tested is omitted in FIGS. 1 to 5 for reasons of clarity. The projecting or elevated electrically conductive elements in each case provide the contact-connection to the electronic circuit unit 200 to be tested.

As contact-connection elements of this type, FIG. 1 illustrates the contact-connection elements 106 for the conductor tracks 104 and the contact-connection elements 107 for the conductor tracks 105. The method according to the invention for producing a contact-connection device enables deposition of the electrically conductive structures to be provided no longer only in planar fashion but also in three dimensions.

Consequently, as illustrated in FIG. 1, it is possible for conductor tracks 104 and 105 to run from a respective conductor track connecting element 102 and 103 to the corresponding contact-connection element 106 and 107, respectively, from the plane of the adapter board 100.

In this way, it is possible to provide contact-connection regions in elevated or projecting fashion in the form of the contact-connection elements 106 and 107 and to use an elastic effect of the elastic element 107. As illustrated in FIG. 1, the elastic element 101 is embodied in the form of a semi-cylinder. It should be pointed out that other cross-sectional forms of the elastic element may also be provided.

By way of example, in a further embodiment (not shown), the elastic element has, in cross section, a slightly tilted “s” rising from the left (FIG. 1) and a mirrored “s” rising from the right (FIG. 1). This double s form in a gradient of the rising edge enables a shallow transition from the adapter board 100 to the elastic element 101.

One advantage of the method according to the invention for producing the contact-connection device is that both the elastic element 101 and the conductor track connecting elements 102, 103, the conductor tracks 104, 105 and also the contact-connection elements 106, 107 can be deposited by means of a thick-film/thin-film technology, for example. The materials of the contact-connection device in accordance with the preferred exemplary embodiment of the present invention as shown in FIG. 1 can be varied within wide ranges. In a preferred exemplary embodiment, the adapter board 100 is formed from ceramic or silicon.

The form of the elastic semi-cylinder is preferably deposited on this adapter board using printing technology. This is preferably provided in a plurality of printing processes. Multiple utilization of such printing processes and provision of multiple printing make it possible to provide arbitrary shallow and steep gradients in the transition between the adapter board 100 and the elastic element 101. The material of the elastic element 101 is preferably nonconductive and, in a preferred exemplary embodiment, comprises silicone.

Silicone has the advantage that it is both elastic and thermostable, thereby permitting testing at an elevated temperature. What is more, the silicone has a low spring constant of approximately 0.1 g/μm, with the result that only low forces are necessary for the contact-connection of an electronic circuit unit 200 to be tested. Metallization of conductive elements of the contact-connection device and of leads is advantageously effected by means of a sputtering technique and subsequent electrochemical reinforcement.

In this case, copper, Cu, serves as the material of the conductor tracks 104, 105, gold, Au, serves as a covering layer and nickel, Ni, serves as a buffer layer between copper and gold. A structural design is effected by means of photolithographic processes according to the prior art.

A pitch distance between the contact-connection elements 106, 107 is typically 100 μm, down to 50 μm. All customary electronic circuit units to be tested can thus advantageously be contact-connected in the nonhoused state.

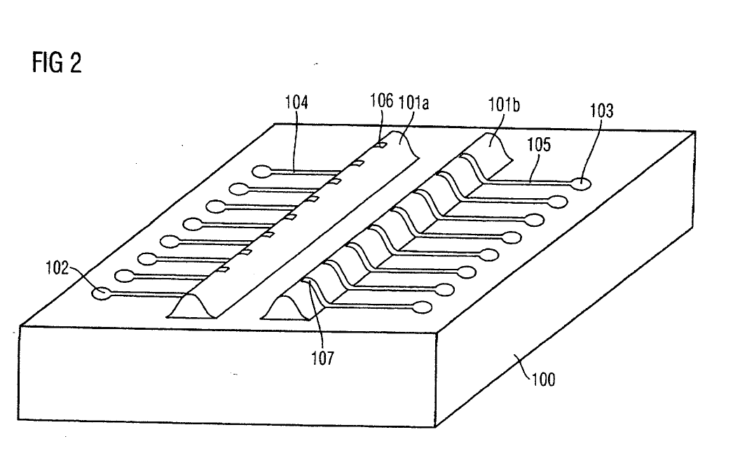

FIG. 2 shows a modification of the exemplary embodiment shown in FIG. 1 to the effect that two elastic elements 101a, 101b are arranged next to one another. As shown in FIG. 2, the conductor tracks 104 are led to the elastic element 101a for connection to the contact-connection elements 106, while the conductor tracks 105 are led to the elastic element 101b for connection to the contact-connection element 107.

Compared with the arrangement in FIG. 1, the arrangement of FIG. 2 has greater flexibility with regard to a connecting possibility of circuit units 200 to the effect that it is possible to take account of different constructional structures of the circuit unit connecting elements 202, see FIG. 6, of the circuit unit 200.

The combined deposition of the elastic elements 101a and 101b, together with the electrically conductive structures that is provided by the thick-film/thin-film technology, affords the advantage of adapting the contact-connection device to circuit units 200 to be tested practically arbitrarily.

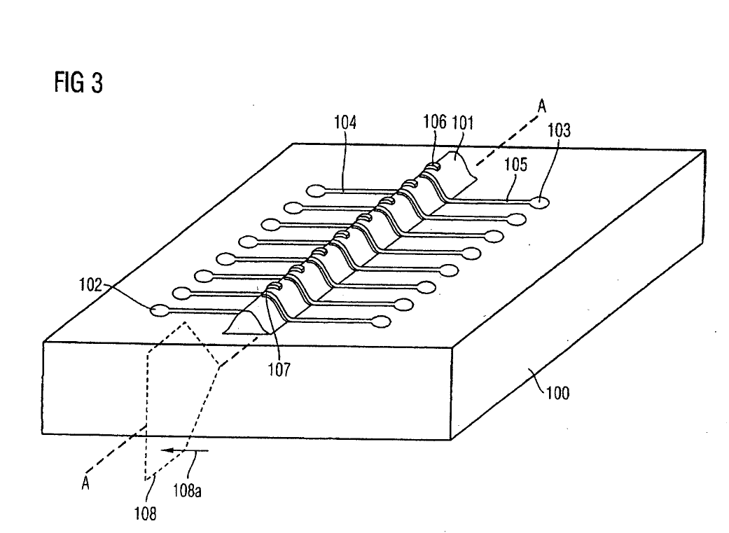

FIG. 3 illustrates a further modification of the arrangement shown in FIG. 1. As can be seen from FIG. 3, the conductive elements fitted on the elastic element 101, i.e. a part of the conductor tracks 104, 105 and the contact-connection elements 106, 107, have a projecting or elevated relief structure.

In the case of specific circuit units 200 to be tested, this relief structure has the advantage that circuit unit connecting elements 202 set back behind a circuit unit board side 201 can also be contact-connected; also see FIG. 6. Such a structure of the contact-connection elements 106, 107 on the elastic element 101 is referred to as a relief structure. This relief-like structure may be achieved, for example, by dry etching of the elastic element between the electrically conductive elements, i.e. between the contact-connection elements 106, 107 and the conductor tracks 104, 105.

The conductor tracks are preferably provided with a hard contact material at the most elevated points, i.e. at the locations of the contact-connection elements 106, 107, which has the advantage that, in addition to circuit unit connecting elements 202 made of gold, such elements made of aluminum or copper can also be contact-connected on the electronic circuit unit 200 to be tested.

Consequently, there is the advantage that the elevated structures have edges and/or tips. If the conductor tracks 104, 105 deposited on the elastic element, and in particular the contact-connection elements 106, 107 deposited on the elastic element, project from the surface of the elastic element 101, a more reliable contact-connection thus results, as shown in FIG. 3.

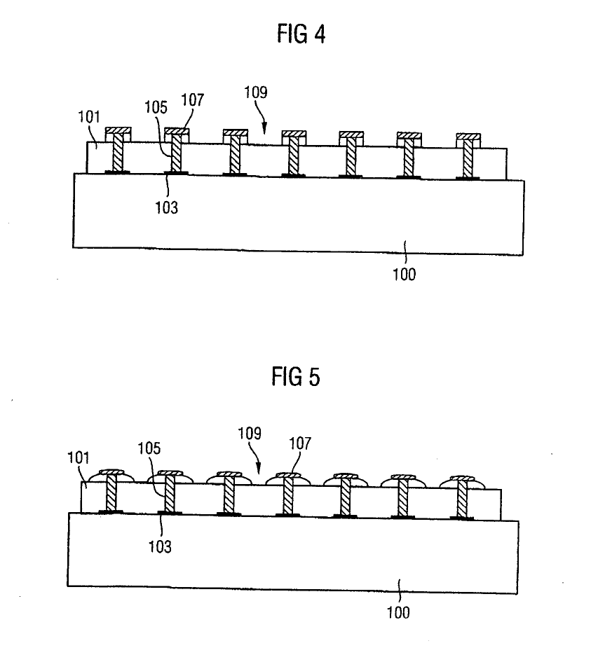

FIG. 4 shows a cross-sectional view resulting from a section along the line A-A of FIG. 3 in the plane represented by the broken line 108 in FIG. 3, as seen from the direction of the arrow 108a in FIG. 3. Consequently, the conductor tracks 105 and the correspondingly assigned contact-connection elements 107 are discernible in the cross-sectional view of FIG. 4.

Furthermore, FIG. 4 illustrates a cutout 109, provided by dry etching in the exemplary embodiment of FIG. 4. A relief structure with sharp edges is thus provided. The way in which such a relief structure is pressed onto the circuit unit board side 201 of the circuit unit 200 during a contact-connection of the electronic circuit unit 200 to be tested will be described below with reference to FIG. 6.

FIG. 5 shows a further relief structure, which, in contrast to the relief structure shown in FIG. 4, is provided by relief printing on the elastic element. Utilization of such a printing process with subsequent multiple printing makes it possible to provide arbitrary shallow and steep gradients as a transition between the elastic element and the elevated locations of the contact-connection elements 106, 107.

FIG. 5 shows a cross-sectional view with regard to the same plane as the cross-sectional view shown in FIG. 4. In contrast to the relief structure illustrated in FIG. 4, the relief structure of FIG. 5 has shallow-rising cutouts 109.

Finally, FIG. 6 shows the cross-sectional view illustrated in FIG. 4 together with a circuit unit 200 to be contact-connected. The circuit unit 200 to be contact-connected is pressed onto the contact-connection device according to the invention in a press-on direction shown by the arrow 303. In this case, the adapter board 100 with the elastic element 101 applied thereto and the conductor tracks 105 and contact-connection elements 107 deposited thereon remains in a rest position, while the circuit unit 200 is pressed downward.

The circuit unit 200 has, as an underside, a circuit unit board side 201 interrupted by cutouts for circuit unit connecting elements 202. As illustrated in FIG. 6, the circuit unit connecting elements 202 are recessed with respect to the plane of the circuit unit board side 201, with the result that the elevated contact-connection elements 106, 107 of the contact-connection device, according to the invention, engage into said circuit unit connecting elements 202 and contact-connect the same. The circuit unit connecting elements 202 are contact-connected by the contact-connection elements 106, 107 at a contact-connection level 301, see broken line in FIG. 6. A compression stop level 302 is reached when the circuit unit board side 201 bears on the top side of the elastic element 101.

Such a relief structure, as is illustrated in FIGS. 4 and 5, thus enables a reliable contact-connection of circuit units 200 to be achieved even when the circuit unit connecting elements 202 thereof are set back with regard to the circuit unit board side 201.

The contact-connection device according to the invention makes it possible for the contact-connection elements 106, 107 to contact-connect the circuit unit connecting elements 202 of the circuit unit 200 in elastically pressing-on fashion.

In this case, there is great flexibility in the configuration of the elastic element 101, since the elastic element only has to provide a thickening region from the surface of the adapter board 100. The thickening region may, for example, issue symmetrically in shallow fashion toward the edges of the thickening region.

It should be pointed out that the cross section of the elastic element does not have to be symmetrical, but rather can assume arbitrary cross-sectional forms. A shallow transition from the adapter board 100 to the elastic element 101 ensures that a tearing away of conductor tracks 104, 105 applied on the adapter board 100 and the elastic element 101 is avoided. It should be pointed out that elastic elements can be applied in an arbitrary geometrical arrangement on the adapter board 100.

While FIG. 1 shows an individual elastic element 101 arranged longitudinally, FIG. 2 illustrates two elastic elements 101a and 101b arranged at a pre-determinable distance. Depending on the circuit unit 200 to be contact-connected, however, it is possible to arrange more than two elastic elements 101 on the adapter board 100.

This leads to further flexibility of the contact-connection device according to the invention. Given a currently achievable adjustment accuracy of 5 μm to 10 μm provided by positioning devices according to the prior art, it thus becomes possible to reliably contact-connect circuit units whose circuit unit connecting elements 202 are at a mutual distance of 100 μm down to 50 μm.

In particular, the advantage of the contact-connection device according to the invention consists in the fact that the circuit units 200 to be contact-connected do not have to be provided with a housing prior to contact-connection.

Although the present invention has been described above on the basis of preferred exemplary embodiments, it is not restricted thereto, but rather can be modified in diverse ways. Moreover, the invention is not restricted to the application possibilities mentioned. In particular, the contact-connection device according to the invention is suitable for the contact-connection of circuit units whose circuit unit connecting elements are at a small mutual distance and which have a high contact density.

### List of Reference Symbols

In the figures, identical reference symbols designate identical or functionally identical components or steps.
100 Adapter board
101, Elastic element
101a,
101b
102, Conductor track connecting element
103
104, Conductor track
105
106, Contact-connection element
107
108 Cross section
109 Cutout
200 Circuit unit
201 Circuit unit board side
202 Circuit unit connecting element
301 Contact-connection level
302 Compression stop level
303 Press-on direction
400 External circuit device

1. A contact-connection device for electronic circuit units having circuit unit connecting elements, comprising:
an adapter board;
at least one elastic element arranged on the adapter board;
conductor tracks deposited on the at least one elastic element and the adapter board;
conductor track connecting elements deposited on the adapter board and electrically connected to the conductor tracks; and
contact-connection elements deposited on the at least one elastic element and electrically connected to the conductor tracks, wherein
the contact-connection elements contact-connect the circuit unit connecting elements of the circuit units in an elastically pressing-on manner.

2. The device according to claim 1, wherein an external circuit device can be connected to the conductor track connecting elements.

3. The device according to claim 1, wherein the elastic element is formed as a semi-cylinder.

4. The device according to claim 2, wherein the elastic element is embodied from a thermo-stable elastic material.

5. The device according to claim 2, wherein the elastic element comprises a silicone material.

6. The device according to claim 1, wherein the elastic element comprises a dielectric material.

7. The device according to claim 1, wherein the elastic element has as a cross-sectional form which ends symmetrically with respect to a thickening region in shallow fashion toward edges of the thickening region.

8. The device according to claim 1, wherein the elastic element comprises an electrically nonconductive material.

9. The device according to claim 1, wherein the contact-connection elements deposited on the elastic element and electrically connected to the conductor tracks have a pitch distance of 50 μm to 150 μm.

10. The device according to claim 1, wherein the elastic element has a cross-sectional form which provides volume-specific elasticity properties.

11. The device according to claim 1, wherein the conductor tracks deposited on the elastic element project from the surface of the elastic element.

12. The device according to claim 1, wherein the conductor tracks deposited on the elastic element and the adapter board are in one row.

13. The device according to claim 1, wherein the conductor tracks deposited on the elastic element and the adapter board are in two or more rows.

14. A method for producing a contact-connection device for electronic circuit units having circuit unit connecting elements, comprising:
providing an adapter board as a carrier plate;
depositing at least one elastic element on the adapter board;
depositing conductor tracks on the adapter board and on the at least one elastic element;
depositing conductor track connecting elements electrically connected to the conductor tracks on the adapter board; and
depositing contact-connection elements electrically connected to the conductor tracks on the at least one elastic element, wherein
the contact-connection elements contact-connect the circuit unit connecting elements of the circuit unit in elastically pressing-on manner.

15. The method according to claim 14, wherein an external circuit device is connected to conductor track connecting elements.

16. The method according to claim 14, wherein the elastic element is deposited as a semi-cylinder.

17. The method according to claim 14, wherein the elastic element is deposited as a thermo-stable elastic material.

18. The method according to claim 14, wherein the elastic element is made from a silicone material.

19. The method according to claim 14, wherein the elastic element is made from a dielectric material.

20. The method according to claim 14, wherein the elastic element is formed in a cross-sectional form which issues symmetrically with respect to a thickening region in shallow fashion toward edges of the thickening region.

21. The method according to claim 14, wherein the elastic element is made from an electrically nonconductive material.

22. The method according to claim 14, wherein the contact-connection elements deposited on the elastic element and electrically connected to the conductor tracks are provided with a pitch distance of 50 μm to 150 μm.

23. The method according to claim 14, wherein volume-specific elasticity properties are provided by the elastic element.

24. The method according to claim 14, wherein the conductor tracks are deposited on the elastic element so that they project from a surface of the elastic element.

25. The method according to claim 14, wherein the conductor tracks deposited on the elastic element and the adapter board are arranged in one row.

26. The method according to claim 14, wherein the conductor tracks deposited on the elastic element and the adapter board are arranged in two or more rows.

27. The method according to claim 14, wherein cutouts are provided between the contact-connection elements by dry etching the elastic element.

28. The method according to claim 14, wherein cutouts are provided between the contact-connection elements by relief printing on the elastic element.

29. The method according to claim 14, wherein the conductor tracks, the contact-connection elements and the conductor track connecting elements are deposited by sputtering technology and subsequent electrochemical reinforcement.
